(19) United States
(12) Patent Application Publication
(10) Pub. No.: US 2015/0052868 A1
(43) Pub. Date: Feb. 26, 2015

(54) LAWN MOWER INCLUDING REDUCED TURBULENCE CUTTING BLADES

(71) Applicant: Ariens Company, Brillion, WI (US)

(72) Inventor: Fredric D. Schreiner, Green Bay, WI (US)

(73) Assignee: Ariens Company, Brillion, WI (US)

(21) Appl. No.: 13/971,464

(22) Filed: Aug. 20, 2013

(51) Int. Cl. A01D 34/73

(52) U.S. Cl. CPC A01D 34/73
USPC 56/17.5; 56/289

(57) ABSTRACT

A cutting blade for use with a lawn mower includes a body having a leading edge, a trailing edge, and an end extending between the leading edge and the trailing edge. The cutting blade also includes a cutting edge formed on the leading edge of the body. The cutting edge includes a radially outermost tip that defines a cutting circumference of the cutting blade. The cutting blade further includes a lift portion coupled to the body and defining at least a portion of the trailing edge. The end of the body at the trailing edge is spaced at least 0.5 inches radially inward from the cutting circumference of the cutting blade.

### FIELD OF THE INVENTION

The present invention relates to lawn mowers and, more particularly, to lawn mowers including cutting blades configured to reduce air turbulence between the cutting blades.

### SUMMARY

In one embodiment, the invention provides a cutting blade for use with a lawn mower. The cutting blade includes a body having a leading edge, a trailing edge, and an end extending between the leading edge and the trailing edge. The cutting blade also includes a cutting edge formed on the leading edge of the body. The cutting edge includes a radially outermost tip that defines a cutting circumference of the cutting blade. The cutting blade further includes a lift portion coupled to the body and defining at least a portion of the trailing edge. The end of the body at the trailing edge is spaced at least 0.5 inches radially inward from the cutting circumference of the cutting blade.

In another embodiment, the invention provides a lawn mower including a frame, a plurality of wheels coupled to the frame, a cutting deck supported by the frame, and a drive assembly supported by the frame. The drive assembly includes a first spindle and a second spindle extending from the cutting deck. The lawn mower also includes a first cutting blade coupled to the first spindle for rotation relative to the cutting deck. The first cutting blade includes a first body having a first leading edge, a first trailing edge, a first end extending between the first leading edge and the first trailing edge, and a first longitudinal axis extending through the first spindle and the first end. The first leading edge defines a cutting edge of the first cutting blade. The lawn mower further includes a second cutting blade coupled to the second spindle for rotation relative to the cutting deck. The second cutting blade includes a second body having a second leading edge, a second trailing edge, a second end extending between the second leading edge and the second trailing edge, and a second longitudinal axis extending through the second spindle and the second end. The second leading edge defines a cutting edge of the second cutting blade. When the first longitudinal axis is generally aligned with the second longitudinal axis such that the first end of the first cutting blade is adjacent the second end of the second cutting blade, the first end and the second end are spaced apart by a first distance measured generally parallel to the first and second longitudinal axes between the first and second leading edges and are spaced apart by a second distance measured generally parallel to the first and second longitudinal axes between the first and second trailing edges. The second distance is at least five times greater than the first distance.

In yet another embodiment, the invention provides a cutting blade for use with a lawn mower. The cutting blade includes a body having a leading edge, a trailing edge, and an end extending between the leading edge and the trailing edge. The cutting blade also includes a cutting edge formed on the leading edge of the body, and a lift portion coupled to the body and defining at least a portion of the trailing edge. The end of the body has a radius of curvature defined by

$$R = \frac{{W}^{2}}{2 D} + \frac{D}{2}$$

where R is the radius of curvature of the end of the body, W is a width of the body measured between the leading edge and the trailing edge, and D is at least 0.5 inches.

Other aspects of the invention will become apparent by consideration of the detailed description and accompanying drawings.

### BRIEF DESCRIPTION OF THE DRAWINGS

FIG. 1 is a top perspective view of a lawn mower.

FIG. 2 is a bottom perspective view of a cutting deck of the lawn mower.

FIG. 3 is a top view of a cutting blade for use with the lawn mower.

FIG. 4 is an end view of the cutting blade of FIG. 3.

FIG. 5 is a top view of the cutting deck with three of the cutting blades of FIG. 3.

FIG. 6 is an enlarged top view of a portion of the cutting deck and two of the cutting blades shown in FIG. 5.

FIG. 7 is a top view of the cutting deck shown in FIG. 5 with three conventional cutting blades.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

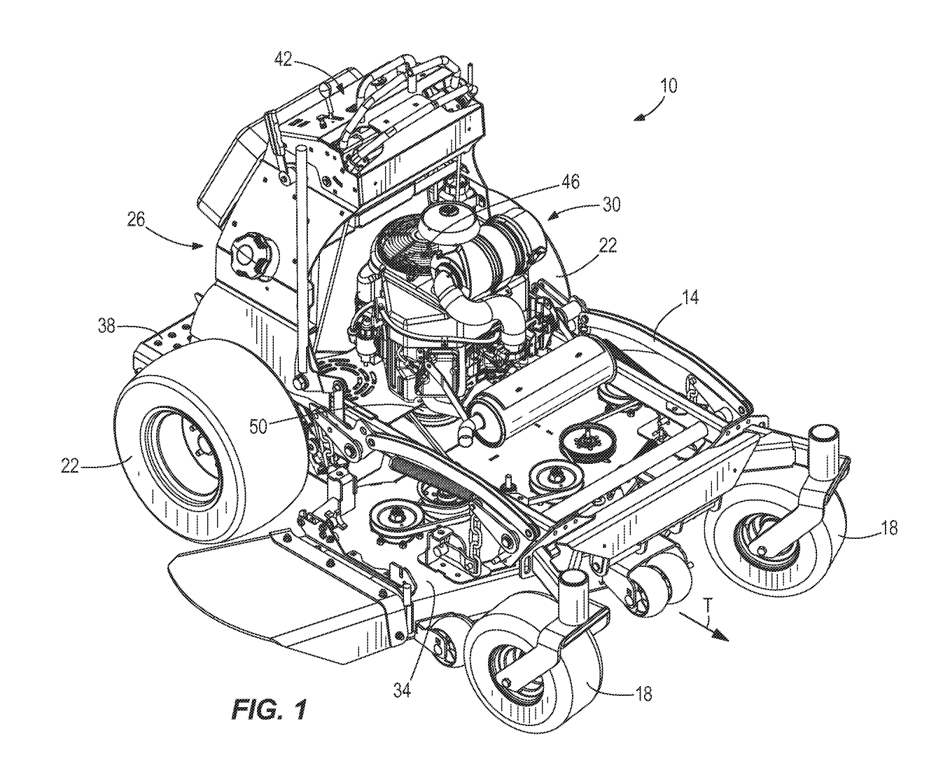

FIG. 1 illustrates a lawn mower 10. In the illustrated embodiment, the lawn mower 10 is a standing ride-on lawn mower, which is a lawn mower on which the operator stands rather than sits. In other embodiments, the lawn mower 10 may be a mid-mount, riding lawn mower or an out-front, walk behind lawn mower. The illustrated lawn mower 10 includes a frame 14, two front wheels 18 coupled to the frame 14, two rear drive wheels 22 coupled to the frame 14, an operator platform and control tower assembly 26, a mower drive assembly 30, and a cutting deck 34. The operator platform and control tower assembly 26, the mower drive assembly 30, and the cutting deck 34 are supported by the frame 14.

The illustrated front wheels 18 are passive wheels, meaning that the wheels 18 are not driven under power. In addition, the front wheels 18 are caster wheels that are mounted to the frame 14 with an arrangement that permits the wheels 18 to swivel with respect to the frame 14. Such an arrangement accommodates turning and rotating of the lawn mower 10. In some embodiments, the front wheels 18 are not passive, but instead can be actively driven and/or steered by an operator.

The rear drive wheels 22 are driven by the mower drive assembly 30. In the illustrated embodiment, the rear drive wheels 22 are capable of rotating independent of one another in forward and reverse directions to cause forward, reverse, and turning movement of the lawn mower 10. If the rear drive wheels 22 rotate in opposite directions (i.e., one forward and one reverse) at the same speed, the lawn mower 10 rotates about a zero-radius turning axis, or zero-turn or ZT axis.

The operator platform and control tower assembly 26 includes a platform 38 on which an operator stands during operation of the lawn mower 10. The assembly 26 also includes controls 42 that are accessible to an operator standing on the platform 38. The controls 42 are coupled to the mower drive assembly 30 and other components of the lawn mower 10 to control operation of the lawn mower 10. For example, the assembly 26 can include an ignition switch, a blade engagement control, a choke, an engine speed control, a height of cut selector, and the like.

The mower drive assembly 30 includes a prime mover 46 and a transmission 50. The illustrated prime mover 46 is an internal combustion engine. In other embodiments, the prime mover 46 may be an electric or hybrid motor that is at least partially powered by a battery, a fuel cell, or other suitable power source. The transmission 50 is coupled to the prime mover 46 and to the rear wheels 22 to drive the rear wheels 22. The transmission 50 is also coupled to the cutting deck 34 to cause cutting blades in the cutting deck 34 to rotate and cut grass or other vegetation.

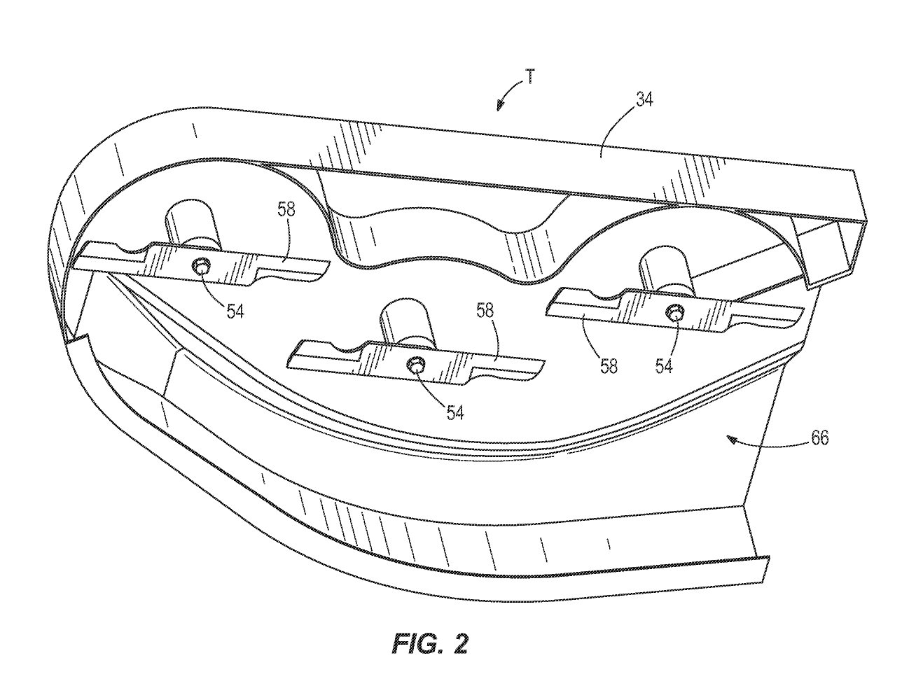

The cutting deck 34 is mounted to the frame 14 generally beneath the mower drive assembly 30 and in front of the operator platform and control tower assembly 26. As shown in FIG. 2, three spindles 54, or drive shafts, extend from the cutting deck 34 to support three cutting blades 58. The spindles 54 are coupled to the mower drive assembly 30 and operable to be rotated by the transmission 50 during operation of the lawn mower 10. The cutting deck 34 defines a cutting space 66 in which the cutting blades 58 are rotated by the spindles 54. In the illustrated embodiment, the middle spindle 54 is positioned forward of the two side spindles 54 in a direction of travel T of the lawn mower 10 such that the cutting blades 58 are staggered relative to the cutting deck 34. In other embodiments, the spindles 54 and the cutting blades 58 may be arranged in other configurations on the cutting deck 34.

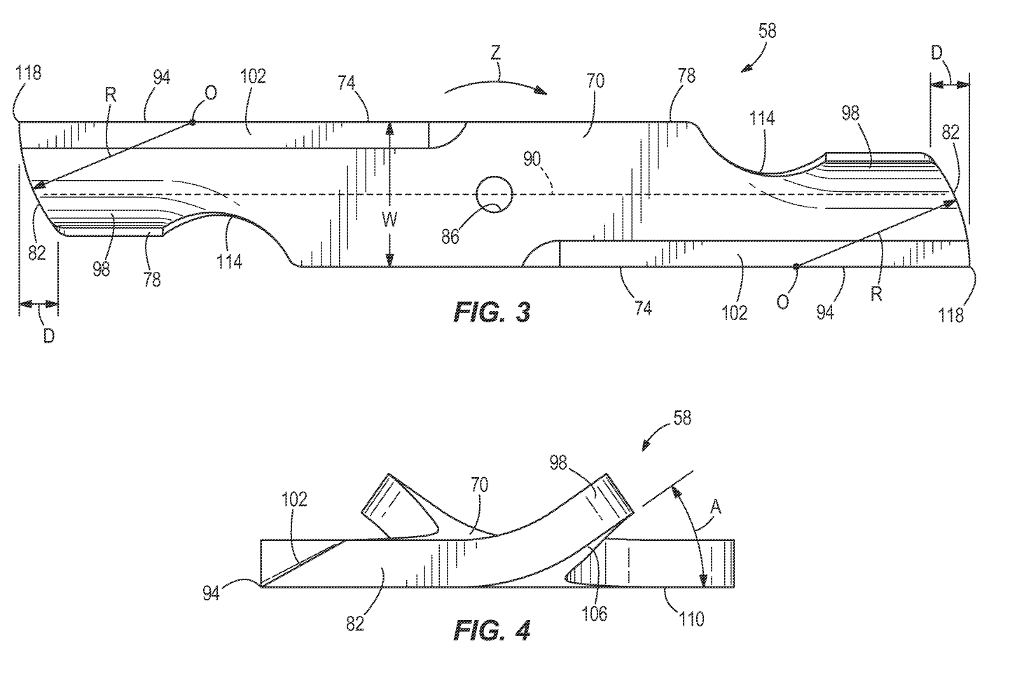

FIGS. 3 and 4 illustrate one of the cutting blades 58 in more detail. Although only one of the three cutting blades 58 is illustrated in detail, the other two cutting blades 58 are substantially the same as and interchangeable with the illustrated blade 58. In addition, the illustrated cutting blade 58 is symmetrical about its central axis (i.e., an axis coaxial with the corresponding spindle 54). As such, only one half of the cutting blade 58 is described in detail. The other half of the cutting blade 58 is the same as the half described below, and like parts have been given the same reference numbers.

The cutting blade 58 includes a body 70 having a leading edge 74, a trailing edge 78, and an end 82 extending between the leading edge 74 and the trailing edge 78. The leading edge 74 is located on a forward side of the body 70 in a direction of rotation Z of the cutting blade 58. The trailing edge 78 is located on a rearward side of the body 70 in the direction of rotation Z of the cutting blade 58. The end 82 connects the leading and trailing edges 74, 78, and an overall length of the cutting blade 58 is defined between the opposing ends 82.

The body 70 also defines a mounting hole 86 and a longitudinal axis 90. The mounting hole 86 is configured to receive one of the spindles 54 (FIG. 2) to rotatably mount the cutting blade 58 to the cutting deck 34. The longitudinal axis 90 extends through the mounting hole 86 and the ends 82 of the body 70. Because the cutting blade 58 is configured for mounting at the mounting hole 86 and rotation about the axis of the associated spindle 54, the direction from the mounting hole 86 toward the respective ends 82 along the longitudinal axis 90 is referred to as the radial direction. The radial length of the cutting blade 58 is half the blade length. The blade 58 may be characterized as having radial mirror symmetry because the blade is symmetrical in the radial direction when mirrored about the longitudinal axis 90.

The cutting blade 58 also includes a cutting edge 94 and a lift portion 98. The body 70, the cutting edge 94, and the lift portion 98 are integrally machined or formed from a single piece of material, such as stainless steel. In other embodiments, portions of the cutting blade 58 may be manufactured as separated pieces that are later welded or otherwise permanently secured together.

The cutting edge 94 is formed on the leading edge 74 of the body 70. The cutting edge 94 is a sharpened edge of the body 70 suitable for cutting grass or other vegetation. The illustrated cutting edge 94 is defined by a chamfered surface 102 of the body 70. The cutting edge 94 extends from the end 82 of the body 70 toward the mounting hole 86 and is generally parallel to the longitudinal axis 90. When the cutting blade 58 is rotated relative to the cutting deck 34, the cutting edge 94 cuts grass or other vegetation located beneath the deck 34.

The lift portion 98 is formed on and extends from the body 70 opposite the cutting edge 94 to define at least a portion of the trailing edge 78. The illustrated lift portion 98 extends from the end 82 of the body 70 toward the mounting hole 86 and is a section of the body 70 that bends out of plane with the remainder of the body 70. In the illustrated embodiment, the lift portion 98 only extends part of the distance (e.g., less than 50% of the distance) from the end 82 of the body 70 to the mounting hole 86. Furthermore, as shown in FIG. 4, the lift portion 98 is bent generally toward the cutting deck 34. In the illustrated embodiment, a lower surface 106 of the lift portion 98 is bent at an angle A of about 35 degrees toward the cutting deck 34 relative to a lower surface 110 of the remainder of the body 70. In other embodiments, the lift portion 98 may extend a further or lesser distance from the end 82 to define more or less of the trailing edge 78, and/or the lift portion 98 may be bent at a greater or lesser angle relative to the body 70.

Referring back to FIG. 3, a cutout or recess 114 is formed in the trailing edge 78 of the body 70. The recess 114 provides a transition between the lift portion 98 and the body 70. In other embodiments, other suitable lift portions may also or alternatively be formed on or coupled to the body 70 of the cutting blade 58.

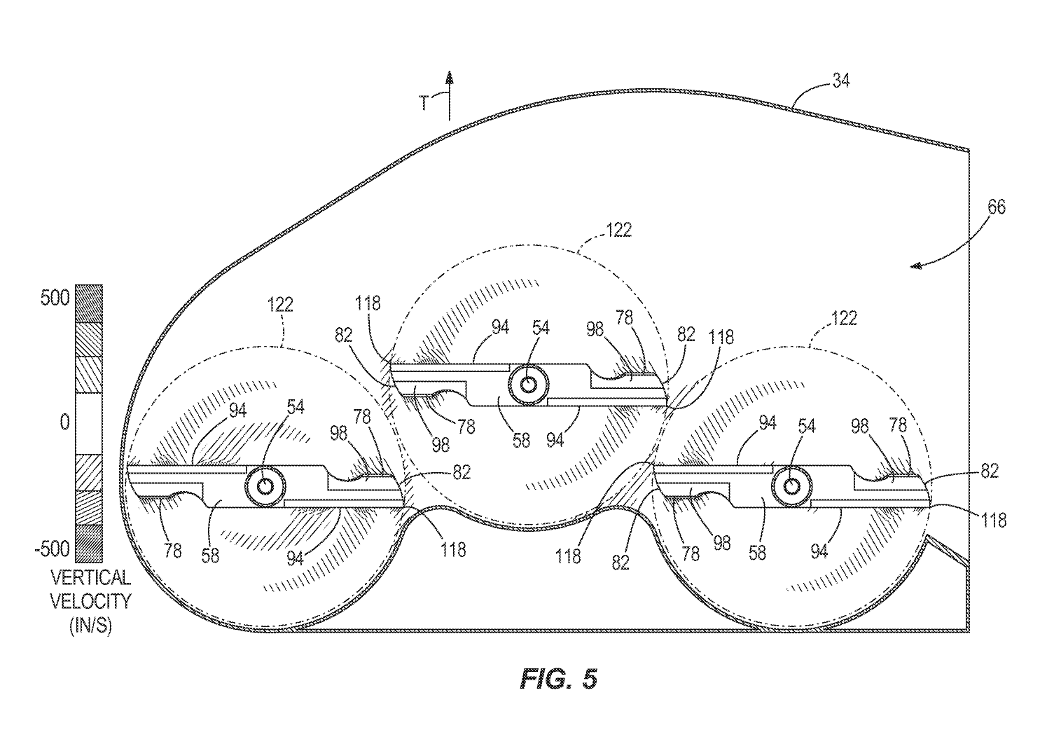

As shown in FIG. 5, a radially outermost tip 118 of the cutting edge 94 on each cutting blade 58 defines a cutting circumference 122 of the corresponding blade 58. The spindles 54 and the cutting blades 58 are arranged in a staggered line on the cutting deck 34 so that the cutting circumference 122 defined by the middle cutting blade 58 is positioned forward of the cutting circumferences 122 defined by the side cutting blades 58 in the direction of travel T of the lawn mower 10. The cutting circumferences 122 defined by the two side cutting blades 58 are also immediately adjacent (i.e., almost touching) the cutting circumference 122 defined by the middle cutting blade 58. Such an arrangement provides some overlap (e.g., about 1.25 inches of overlap) between the cutting circumferences 122 in the direction of travel T of the lawn mower 10 to eliminate gaps or spaces between the cutting blades 58.

The illustrated cutting blade 58 is configured so that the end 82 of the body 70 at the trailing edge 78 is positioned radially inward of the end 82 of the body 70 at the leading edge 74. The end 82 thereby creates a relief in the body 70 of the cutting blade 58 to reduce turbulence between adjacent cutting blades 58 during operation of the lawn mower 10. In the illustrated embodiment, the end 82 of the body 70 tapers radially inward from the leading edge 74 such that the end 82 of the body 70 at the trailing edge 78 is spaced apart from the cutting circumference 122.

As shown in FIG. 3, the trailing edge 78 is spaced radially inward from the outermost tip 118 of the cutting edge 94 (and, thereby, from the cutting circumference 122) by an offset distance D. In the illustrated embodiment, the offset distance D is at least 0.5 inches. In further embodiments, the offset distance D may be between about 0.5 inches and about 1 inch such that the end 82 of the body 70 at the trailing edge 78 is spaced between about 0.5 inches and about 1 inch radially inward from the cutting circumference 122. In other embodiments, the offset distance D may be greater than 1 inch.

In the illustrated embodiment, the end 82 of the body 70 is curved between the leading edge 74 and the trailing edge 78 and has a radius of curvature R. The illustrated end 82 is continuously curved so that the radius of curvature R is generally constant between the leading and trailing edges 74, 78. In addition, an origin O of the radius of curvature R is located on the cutting edge 94 such that no portion of the cutting blade 58 extends radially beyond the outermost tip 118 of the cutting edge 94.

The illustrated radius of curvature R is defined by

$$R = \frac{{W}^{2}}{2 D} + \frac{D}{2}$$

where R is the radius of curvature of the end 82 of the body 70, W is a width of the body 70 measured between the leading edge 74 and the trailing edge 78 generally perpendicular to the longitudinal axis 90, and D is a constant. The constant D can also be referred to as the “offset” in the radial direction between the radially outermost tip 118 of the cutting edge 94 (or leading edge 74) and the radially outermost tip of the trailing edge 78. In the illustrated embodiment, D is at least 0.5 inches. In other configurations, D may be between about 0.5 inches and about 1 inch. In some embodiments, the width W of the body 70 of the cutting blade 58 is between about 2 inches and about 3 inches. In other embodiments, the width W of the body 70 may be larger or smaller.

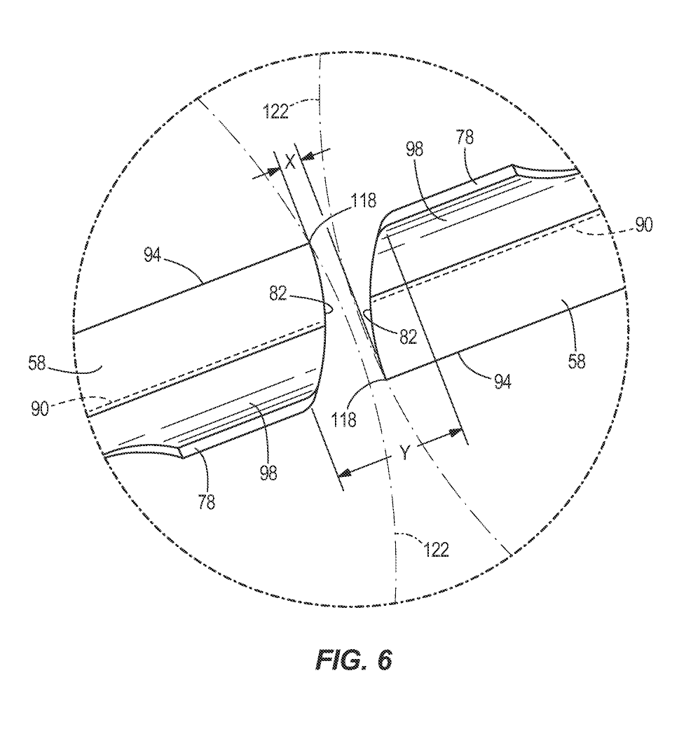

FIG. 6 illustrates portions of two cutting blades 58 when the cutting blades 58 are rotated to a position where the longitudinal axes 90 of the cutting blades 58 are generally aligned, or coaxial, and the ends 82 of the cutting blades 58 are adjacent each other. When in this position, the ends 82 are spaced apart by a first distance X measured generally parallel to the longitudinal axes 90 between the leading edges 74 of the cutting blades 58. In addition, the ends 82 are spaced apart by a second distance Y measured generally parallel to the longitudinal axes 90 between the trailing edges 78 of the cutting blades 58. The second distance Y is at least five times greater than the first distance X due to the curvature of the ends 82. For example, in the illustrated embodiment, the first distance X is about 0.25 inches, and the second distance Y is about 1.25 inches. In other embodiments, the second distance Y may be at least 1.25 inches, depending on the desired offset D and the amount of curvature of the ends 82 of the cutting blades 58.

In other embodiments, the offset D can be achieved without the illustrated smooth curve. For example, in some embodiments, only a portion of the end 82 of the body 70 may be curved between the leading edge 74 and the trailing edge 78. In other embodiments, the end 82 of the body 70 may taper along a straight line or plane between the leading edge 74 and the trailing edge 78. In further embodiments, a jog or cutout may be formed in the end 82 of the body 70 to establish the offset D.

A pair of adjacent cutting blades 58, each having the offset D configuration, provides a means to reduce striping between adjacent cutting blades 58. Striping is the effect of leaving a continuous line, strip, or stripe of uncut grass after the lawn mower 10 passes over the grass. Striping may occur when, for example, turbulence and interference between adjacent cutting blades 58 creates downward air velocities or pressure on the grass, pushing the grass away from the cutting blades 58. The cutting blades 58 will then rotate above the grass without contacting and cutting the grass. With an offset D on each blade, the highest velocity portions of the cutting blades 58 (i.e., the lift portions 90) are separated despite the radially outermost tips 118 being as close as possible to each other. Separating the highest velocity portions of the cutting blades 58 from each other minimizes turbulence generated between adjacent cutting blades 58 as the blades 58 rotate relative to the cutting deck 34 and pass each other.

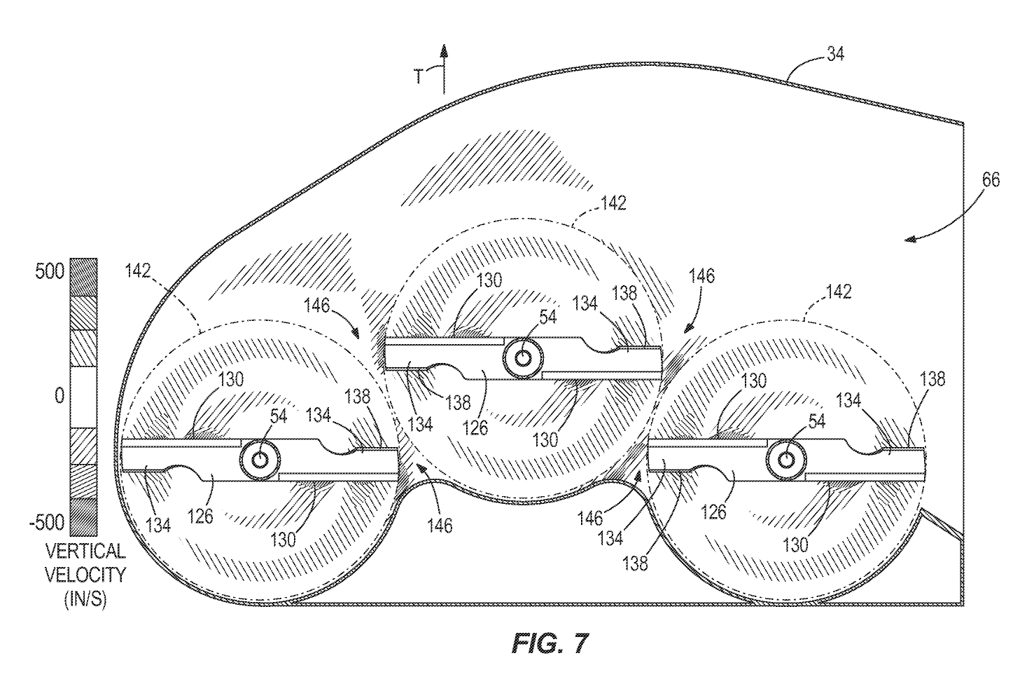

FIG. 7 illustrates the cutting deck 34 of the lawn mower 10 with three conventional cutting blades 126. The illustrated conventional cutting blades 126 include cutting edges 130 and lift portions 134 that define trailing edges 138. The cutting blades 126 are “conventional” in that the lift portions 134 and the trailing edges 138 are only minimally offset from cutting circumferences 142 defined by the cutting edges 130. In other words, the offset dimension D for such blades is very low or zero.

When the conventional cutting blades 126 are rotated by the spindles 54, relatively large downward (i.e., negative) air velocities are created by the cutting blades 126, especially in areas 146 between adjacent cutting circumferences 142. The air velocities are vertical velocities moving away from the cutting deck 34 (into the page, as shown in FIG. 7). The large air velocities create a downward pressure on the grass, pushing the grass away from the cutting deck 34 and the cutting blades 126. As such, as the lawn mower 10 passes over the grass, portions of the grass remain uncut, resulting in striping of the lawn.

FIG. 5 illustrates the same cutting deck 34 of the lawn mower 10 as FIG. 7, but with three cutting blades 58 embodying the invention. Due to the inward offset D of the lift portions 98 and the trailing edges 78 of the cutting blades 58, downward (i.e., negative) air velocities created during rotation of the cutting blades 58 are significantly reduced compared to the cutting blades 126 having minimal offset D shown in FIG. 7. The grass is therefore not pushed as forcefully away from the cutting deck 34 and the cutting blades 58 in the arrangement of FIG. 5. Instead, only relatively small portions of the grass are affected by downward air velocities created by the cutting blades 58. Furthermore, the turbulence behind each cutting blade 58 during rotation is reduced so that air flow in front of each cutting edge 94 is more calm or neutral. As such, the illustrated cutting blades 58 with offset lift portions 90 reduce striping of the grass during operation of the lawn mower 10.

Various features and advantages of the invention are set forth in the following claims.

What is claimed is:

1. A cutting blade for use with a lawn mower, the cutting blade comprising:
a body having a leading edge, a trailing edge, and an end extending between the leading edge and the trailing edge;
a cutting edge formed on the leading edge of the body, the cutting edge including a radially outermost tip that defines a cutting circumference of the cutting blade; and
a lift portion coupled to the body and defining at least a portion of the trailing edge;
wherein the end of the body at the trailing edge is offset at least 0.5 inches radially inward from the cutting circumference of the cutting blade.

2. The cutting blade of claim 1, wherein the end of the body at the lift portion is offset between about 0.5 inches and about 1 inch radially inward from the cutting circumference of the cutting blade.

3. The cutting blade of claim 1, wherein at least a portion of the end of the body is curved between the leading edge and the trailing edge to create the offset.

4. The cutting blade of claim 3, wherein the end of the body is continuously curved from the leading edge to the trailing edge.

5. The cutting blade of claim 3, wherein the curved end of the body has a radius of curvature, and wherein an origin of the radius of curvature is located on the cutting edge.

6. The cutting blade of claim 1, wherein the end of the body is a first end, wherein the body has a second end opposite the first end, and wherein the second end of the body is shaped similar to the first end of the body.

7. A lawn mower comprising:
a frame;
a plurality of wheels coupled to the frame;
a cutting deck supported by the frame;
a drive assembly supported by the frame, the drive assembly including a first spindle and a second spindle extending from the cutting deck;
a first cutting blade coupled to the first spindle for rotation relative to the cutting deck, the first cutting blade including a first body having a first leading edge, a first trailing edge, a first end extending between the first leading edge and the first trailing edge, and a first longitudinal axis extending through the first spindle and the first end, the first leading edge defining a cutting edge of the first cutting blade; and
a second cutting blade coupled to the second spindle for rotation relative to the cutting deck, the second cutting blade including a second body having a second leading edge, a second trailing edge, a second end extending between the second leading edge and the second trailing edge, and a second longitudinal axis extending through the second spindle and the second end, the second leading edge defining a cutting edge of the second cutting blade;
wherein, when the first longitudinal axis is generally aligned with the second longitudinal axis such that the first end of the first cutting blade is adjacent the second end of the second cutting blade, the first end and the second end are spaced apart by a first distance measured generally parallel to the first and second longitudinal axes between the first and second leading edges and are spaced apart by a second distance measured generally parallel to the first and second longitudinal axes between the first and second trailing edges, and wherein the second distance is at least five times greater than the first distance.

8. The lawn mower of claim 7, wherein the second distance is at least 1.25 inches.

9. The lawn mower of claim 8, wherein the first distance is about 0.25 inches.

10. The lawn mower of claim 7, wherein a direction between the first spindle and the first end along the first longitudinal axis is a first radial direction; wherein a direction between the second spindle and the second end along the second longitudinal axis is a second radial direction; wherein the first end of the first cutting blade is curved to create an offset in the first radial direction between the first leading edge and the first trailing edge; and wherein the second end of the second cutting blade is curved to create an offset in the second radial direction between the second leading edge and second trailing edge.

11. The lawn mower of claim 7, wherein the first cutting blade includes a first lift portion that defines at least a portion of the first trailing edge, and wherein the second cutting blade includes a second lift portion that defines at least a portion of the second trailing edge.

12. The lawn mower of claim 11, wherein the first lift portion of the first cutting blade is bent relative to the first body toward the cutting deck, and wherein the second lift portion of the second cutting blade bends relative to the second body toward the cutting deck.

13. The lawn mower of claim 7, wherein the first spindle is positioned forward of the second spindle in a direction of travel of the lawn mower.

14. A cutting blade for use with a lawn mower, the cutting blade comprising:
a body having a leading edge, a trailing edge, and an end extending between the leading edge and the trailing edge;
a cutting edge formed on the leading edge of the body; and
a lift portion coupled to the body and defining at least a portion of the trailing edge;
wherein the end of the body has a radius of curvature defined by
$$R = \frac{{W}^{2}}{2 D} + \frac{D}{2}$$
where R is the radius of curvature of the end of the body, W is a width of the body measured between the leading edge and the trailing edge, and D is at least 0.5 inches.

15. The cutting blade of claim 14, wherein an origin of the radius of curvature is located on the cutting edge.

16. The cutting blade of claim 14, wherein D is between about 0.5 inches and about 1 inch.

17. The cutting blade of claim 16, wherein W is between about 2 inches and about 3 inches.

18. The cutting blade of claim 14, wherein the end of the body is a first end, wherein the body has a second end opposite the first end, and wherein the second end of the body is shaped similar to the first end of the body
